(19) United States
(12) Patent Application Publication
(10) Pub. No.: US 2024/0354879 A1
(43) Pub. Date: Oct. 24, 2024

(54) ALERTS FOR PATENT PROSECUTION METHOD AND TOOL

(71) Applicant: Black Hills IP Holdings, LLC, Minneapolis, MN (US)

(72) Inventor: Steven W. Lundberg, Edina, MN (US)

(21) Appl. No.: 18/645,124

(22) Filed: Apr. 24, 2024

Related U.S. Application Data
(60) Provisional application No. 63/461,523, filed on Apr. 24, 2023.

(51) Int. Cl. G06Q 50/18; G06F 3/04847; G06F 40/18

(52) U.S. Cl. CPC G06Q 50/184; G06F 40/18; G06F 3/04847

(57) ABSTRACT

Various embodiments disclosed relate to spreadsheet driven alert methods and tools for patent prosecution. The present disclosure includes a method including: producing a user-configurable database on a user interface, the database describing a plurality of matters, wherein for each of the plurality of matters, each of the plurality of matters associated with one or more parameters, receiving an indication in a change in the one or more parameters; creating one or more embedded alerts in the spread sheet according to the change in the one or more parameters, each of the one or more embedded alerts associated with one of the plurality of matters; and notifying a user of one or more embedded alerts in the database.

### CLAIM OF PRIORITY

This application claims the benefit of priority under 35 U.S.C. § 119 (e) to U.S. Provisional Patent Application Ser. No. 63/461,523, filed on Apr. 24, 2023, which is incorporated by reference herein in its entirety.

### BACKGROUND

In a business, docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that may require a response. However, in a general docketing setting, a large number of items and tasks are incoming and often need to be sorted during docketing. Typically, many deadlines and reminders are created to manage such a system and portfolio.

### SUMMARY OF THE DISCLOSURE

In an example, a method can include: producing a user-configurable spreadsheet user interface, the spreadsheet user interface describing a plurality of matters, wherein each of the plurality of matters is associated with one or more parameters; receiving an indication in a change in the one or more parameters; creating one or more embedded alerts in the spreadsheet user interface according to the change in the one or more parameters, each of the one or more embedded alerts associated with one of the plurality of matters; and notifying a user of the one or more embedded alerts in the spreadsheet user interface.

In an example, a computer readable medium including a processor and a memory, the memory including instructions which when executed, cause the processor to: produce a user-configurable spreadsheet user interface, the spreadsheet user interface describing a plurality of matters, wherein each of the plurality of matters is associated with one or more parameters; receive an indication in a change in the one or more parameters; create one or more embedded alerts in the spreadsheet user interface according to the change in the one or more parameters, each of the one or more embedded alerts associated with one of the plurality of matters; and notify a user of the one or more embedded alerts in the spreadsheet user interface.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a schematic of an automated patent docketing system in an example.

FIG. 2 depicts third-party data sources in an example.

FIG. 3 is a schematic diagram of a docketing system including a spreadsheet alert tool in an example.

FIG. 4 depicts a schematic of a user interface for use with a spreadsheet alert tool in an example.

FIG. 5 depicts a method of using a spreadsheet alert tool in an example.

FIG. 6 depicts a method of using a spreadsheet alert tool in an example.

FIG. 7 depicts a method of using a spreadsheet alert tool in an example.

FIG. 8 depicts a method of using a spreadsheet alert tool in an example.

FIG. 9 depicts a method of using a spreadsheet alert tool in an example.

FIG. 10 depicts a computer system in an example.

### DETAILED DESCRIPTION

The present disclosure describes, among other things, a method of using a database application to configure alerts in an automated docketing system. The database application can be used to simultaneously update batches of alerts, such as with related parameters. This can help avoid time consuming individualized updates. In some cases, the database tool can be used to configure alerts to track and show error conditions between related parameters.

The database can be used to produce a user-configurable spreadsheet user interface. Within this user interface alerts can be displayed to a user to bring attention to any changes in a project's parameters.

In some cases, alerts can be set up based on various rules, such as phase rules, to allow for optional alerts to a user as work is being done on various phases of a project. Such alerts can allow for flagging of inconsistencies between various parameters related to projects in a database system, such as a docketing system. For example, docketing choices or date inconsistencies can be flagged based on data imported into the database.

In an example, a specific phase rule can be built that triggers a specific identification code related to a project or project phase. When the phase rule is triggered, an alert engine can notify a user whenever that specific identification code is true and/or fulfilled. In an example, a specific project may have three days left before a deadline, and the item needed to fulfill that deadline is still not done. In this case, an alert can trigger to the user to notify that an upcoming deadline is not yet met. Special conditions can be applied, such as international rules, governmental rules, or other types of conditions that could trigger alerts.

As used herein, “electronic communication” refers to an electronic message or a method of exchanging messages between people using electronic devices.

As used herein, “template” can include a preset format for a document or file, used so that the format does not have to be recreated each time it is used. In some cases, a template can include one or more fields to be filled out.

As used herein, “application” or “program” can include a program or piece of software designed and written to fulfill a particular purpose of the user, such as a database application.

As used herein, “associate” can include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping,” “web scraping,” “data scraping,” or “web crawling,” can refer to automatically mining or collecting data or information, such as from a database or from the internet.

As used herein, “file” or “matter” can refer to a particular project, enterprise, or undertaking being worked on by an individual or a collaborative group, planned and designed to achieve a particular aim.

As used herein, “official record,” or “file history,” can refer to data about a file or matter denoting evidence about past events or tasks within that file or matter, such as an electronic record of previous events in the file or matter. An “official record” can be stored with and maintained by an overseeing agency or organization, such as a governmental organization.

As used herein, “database,” can refer to a structured set of data, such as held in a computer or on the internet, that can be accessible in various ways.

As used herein, “deadline” refers to a target completion date. Deadlines may be set internally, externally, by a third party, or by a governmental agency.

As used herein, “reminder” refers to a prompt or message to a user that indicates a task to be completed.

As used herein, “extension” refers to an extension or postponement of a deadline. For example, an extension may be movement of a deadline date to a later time, for the payment of a fee with a governmental entity.

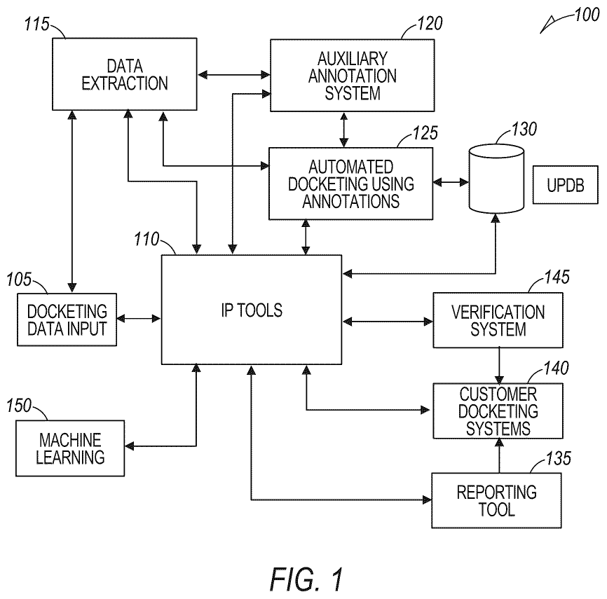

FIG. 1 is a block diagram of a docketing system 100 in an example. The docketing system 100 can be automated or semi-automated. The docketing system 100 can include docketing data input 105, docketing manager 110, data extraction system 115, auxiliary annotation system 120, automated docketing using annotations 125, Universal Procedures Database 130, reporting tool 135, customer docketing system 140, verification system 145, and machine learning model system 150.

The automated docketing system 100 can receive documents from third-party sources including third-party docketing systems and/or customer data as docketing data input 105. The docketing manager system 110 can process the received documents to provide to a customer docketing system 140 and prepare the documents for data extraction by the data extraction system 115 as needed.

The data extraction system 115 can perform Optical Character Recognition (OCR) on the received documents from the docketing manager system 110 to extract data, read checkboxes, extract lists, and identify documents where possible. The docketing manager system 110 can also integrate with a Universal Procedures Database (UPDB) 130 to provide automated docketing by an automated docketing tool 125. The automated docketing tool 125 processes received documents based on additional annotations added to the documents through complex data extraction performed by the Auxiliary Annotation System (AAS) 120.

The AAS 120 may further identify the received documents without using an OCR. To manage this process, the docketing manager system 110 can receive frequent updates of docketing procedure rules including configuration data and updates the UPDB 130 with universal procedure codes (UPCs) as appropriate. The UPCs can be used in conjunction with customer specific codes, checklists, and templates. The rules can specify how to fill in the templates and how to complete customer-specific procedures such as how to docket documents into a customer docketing system 140, for example. The template can be filled out by pulling in attributes from the annotations in a document.

The docketing manager system 110 can receive or intake documents and docketing data from several different sources of docketing data input 105, validate the docketing items against entries in a customer's docketing system 140, and communicate those documents to the customer's docketing system 140 via a unified interface. The docketing manager system 110 can also route documents and associated docketing data through the data extraction system 115 and the AAS 120 and organizes the returned metadata and annotations. The docketing manager system 110 thus can provide a breakout between the metadata and the document text.

The docketing manager system 110 can also keep records and communicate with third-party application programming interfaces (APIs) to push the docketing data and documents automatically where allowed. Otherwise, the docketing manager system 110 can present the documents to human docketers to docket. The docketing manager system 110 may also issue reports upon request.

The docketing manager system 110 can be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update a customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into a customer's docketing system 140.

On the other hand, if the docketing manager system 110 and a customer docketing system 140 are integrated or semi-integrated, the data output may be processed to determine if any data is missing to automate the docketing process. If anything is missing, the human docketer can add that information before the automated docketing process may proceed further or the data may be auto-populated and mapped to the template from the UPDB 130.

The automated docketing system 100 can also perform several post-docketing actions, such as sending docketing reports/details to an external verification system 145 that uses a set of rules to verify proper docketing in a host system. The verification system 145 can verify that the data is correctly added to an external customer's docketing system 140. For example, the verification system 145 can pull data from the AAS 120, the docketing manager system 110, and a customer's docketing system 140 to compare what is present to what is expected to be present in the respective systems.

The automated docketing system 100 may also provide automated email “report out” notifications to customers by implementing a reporting tool 135 that specifies docketing actions based on UPDB template configurations. The reporting tool 135 can also provide completed docketing reports to customers either directly or via a customer's docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 can learn which PTO IDs to use for which documents, which document in a bundle of documents may be used to characterize the bundle, and provide predicted PTO IDs for the received documents. The machine learning model system 150 can also establish rule engine prediction capabilities for received documents that test the classifications.

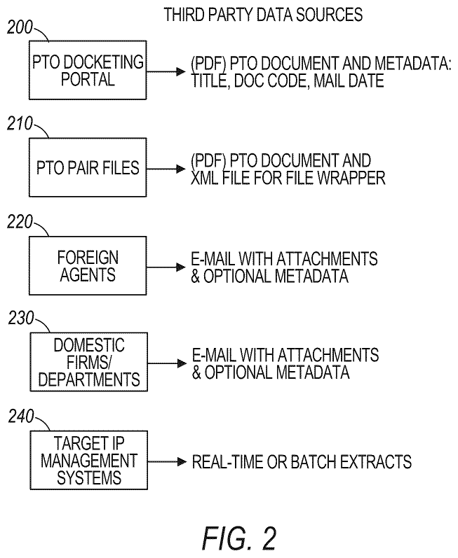

FIG. 2 illustrates sample third party data sources that provide docketing data input 105 for an automated docketing system 100 implemented for managing patent portfolios in an example. As illustrated in FIG. 2, the third-party data sources may include a Patent and Trademark Office (PTO) docketing portal 200, which provides documents from a national PTO in portable document format (PDF) and includes metadata identifying the title, document code, and mail date for the corresponding document. The third-party data sources may further include PTO PAIR extensible markup language (XML) files 210, which provide documents from the PTO in PDF and includes an XML file for patent file wrappers. The third-party data sources may also include foreign agents 220 who provide emails with attachments and optional metadata. Foreign agents 220 may also provide hard copy documents that may be scanned for data entry. Similarly, domestic law firms and/or corporate law departments 230 may provide emails with attachments and optional metadata as well as hard copy documents that may be scanned for data entry. Also, third party docketing systems 240 may provide real-time or batch extracts of data for entry into a docketing management system.

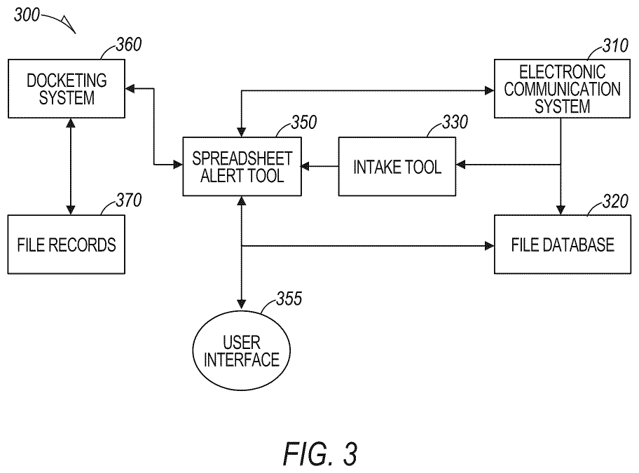

FIG. 3 is a schematic diagram of a docketing system 300 including a spreadsheet driven alert management tool 350.

The system 300 can include, for example, an electronic communication system 310, a file database 320, an intake tool 330, the spreadsheet driven alert management tool 350 with a user interface 355, an automated or semi-automated docketing system 360, and file records 370.

The electronic communication system 310 can be, for example, an e-mail, text, audio, or other means of communicating with internal and external personnel and entities. The electronic communication system 310 can be a user-accessible system for receiving and/or sending messages, such as through a user interface or other computer. The electronic communication system 310 can be, for example, an e-mail server or other communication system.

The file database 320 can include a repository of files or projects being working on by the company. The file database 320 can be, for example, a public or private database, such as a governmental run database. In an example, the USPTO PAIR database can be accessed. In an example, ESPACENET can be accessed. In some cases, other database can be used. In some cases, privately run and updated databases can be accessed. The file database 320 can include information on various files of interest for the business. For example, the file database 320 can include information about patent applications or trademark applications. Such information can, for example, include communications from a governmental agency, responses filed by the company, and other official documents.

The intake tool 330 can include a program or application for receiving electronic communications and associated documents or files. In some cases, the intake tool 330 can be configured to manually or automatically received incoming patent documents or events.

The spreadsheet driven alert management tool 350 can be used to configure alerts to track and show error conditions between related parameters. The spreadsheet driven alert management tool 350 can be, for example, a program or application that is separate from or integrated into the system 300. The spreadsheet driven alert management tool 350 can be in communication with the automated or semi-automated docketing system 360.

The spreadsheet driven alert management tool 350 can be used to produce an alert driven user-configurable spreadsheet user interface including data on one or more patent matters. In some cases, a large number of patent matters can be summarized in the spreadsheet user interface. In some cases, the user-configurable spreadsheet can act as a database. In some cases, the spreadsheet driven alert management tool 350 can automatically or semi-automatically produce and update the spreadsheet user interface.

The spreadsheet can include information on a plurality of patent cases. Such information can include, for example, identifying information such as patent application numbers, docket numbers, patent publication numbers, or patent numbers. Such information can include bibliographic information, such as assignee, inventors, title, agent, patent office, family members, and other information. Such information can include status identifiers or updates.

The spreadsheet driven alert management tool 350 can produce a spreadsheet user interface which can be either automatically, semi-automatically, or manually updated. When updated, the spreadsheet user interface can include, update, or produce one or more embedded alerts corresponding to the various patent matters described therein.

Such embedded alerts can allow for highlighting of error conditions or other events that may require user attention within the produced spreadsheet user interface. For example, if the spreadsheet driven alert management tool 350 includes information pulled from multiple sources, and there is a discrepancy in information from those sources, an embedded alert can notify the user of such. In some cases, where a status identifier is changed on a particular matter in the spreadsheet, the spreadsheet driven alert management tool 350 can produce or update an embedded alert accordingly. Examples of the spreadsheet driven alert management tool 350 in action are discussed below with reference to FIGS. 5-9.

The docketing system 360 can be an automated or semi-automated docketing system, such as the docketing system discussed above with reference to FIG. 1. The docketing system 360 can be in communication with the intake tool 330 and the spreadsheet driven alert management tool 350, and can receive documents, tasks, and communications with the intake tool 330. The docketing system 360 can communicate with and update the file records 370.

The file records 370 can, for example, be a local or cloud-based file storage system including information on files and projects being worked on at or monitored by the company. The file records 370 can contain historical records, such as past events, communications, and decisions in each file.

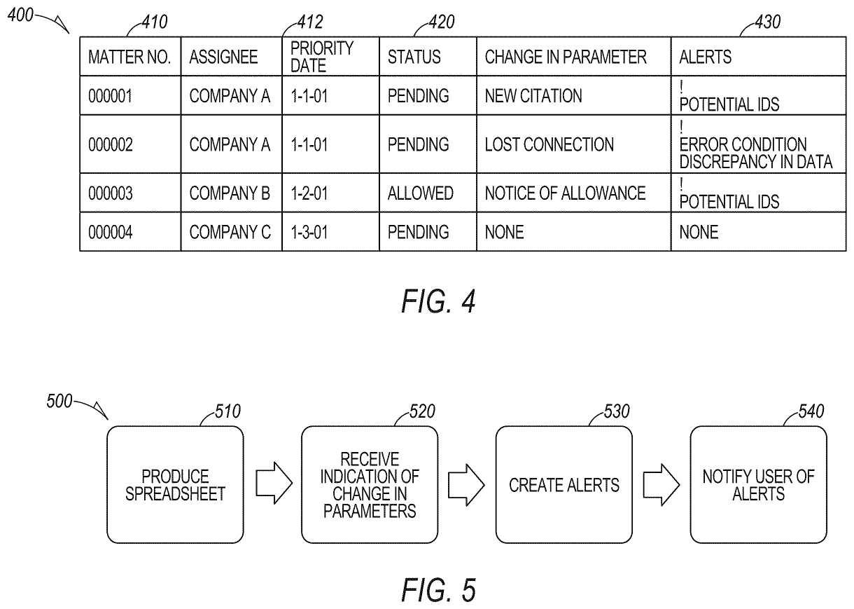

FIG. 4 depicts a schematic of a user-configurable spreadsheet user interface 400 for use with the spreadsheet driven alert management tool 350 in an example. The user interface 400 can be produced by the spreadsheet driven alert management tool 350, and describe a plurality of matters 410. Identifying and bibliographic data 412 can be included. Statuses 420 of the matters can be indicated. Embedded alerts 430 can be included.

FIG. 5 depicts a method 500 of using a spreadsheet alert tool in an example. The method 500 can include steps 510 to 540.

At step 510, the method 500 can include producing a user-configurable spreadsheet on a user interface. The spreadsheet can describe a plurality of matters, wherein each of the plurality of matters is associated with one or more parameters. In an example, the plurality of matters can include patent cases.

Each of the one or more parameters can be associated with a built in phase rule for use in determining an alert to notify the user of. A phase rule can be applied to a matter if a change in parameters is indicated. Once the phase rule is applied, an identification code is established. Identification codes can be associated with alert types such that the fulfilling of a specific identification code results in the associated alert being sent to the user. Fulfilling an identification code can be the result of a phase rule being triggered.

Producing the user-configurable spreadsheet can include automatically or semi-automatically producing data from a docketing system, such as by scraping data from the docketing system. In some cases, producing the user-configurable spreadsheet can include scraping case data from a governmental database.

At step 520, the method 500 can include receiving an indication of a change in the one or more parameters. For example, the one or more parameters can include at least a status of plurality of matters. The status can include one or more of unfiled, pending, published, allowed, granted, issued, expired, completed, restricted, rejected, finally rejected, appealed, or other status indicators. In an example, receiving an indication in a change in the one or more parameters can include receive an indication of an error condition between related parameters.

An indication of a change in the one or more parameters at step 520 can result in the application of an associated built in phase rule. The phase rule can be unique to the specific change in parameters indicated at step 520.

At step 530, the method 500 can include creating one or more embedded alerts in the spreadsheet. This can be done, for example, according to the change in the one or more parameters. Each of the one or more embedded alerts can be associated with one or more of the plurality of matters.

Each of the one or more embedded alerts can be associated with an identification code. The identification code is established once a phase rule has been applied. Identification codes can be associated with alert message types such that only the associated alert message type is sent to the user when the associated identification code is fulfilled. If a phase rule is triggered (for example, if it is two days prior to a deadline and a user has not filed the required document), the associated identification code can be fulfilled.

At step 540, the method 500 can include notifying a user of one or more embedded alerts in the spreadsheet. The user can be notified within the spreadsheet user interface, within a different user interface, by electronic communication, or by other appropriate methods.

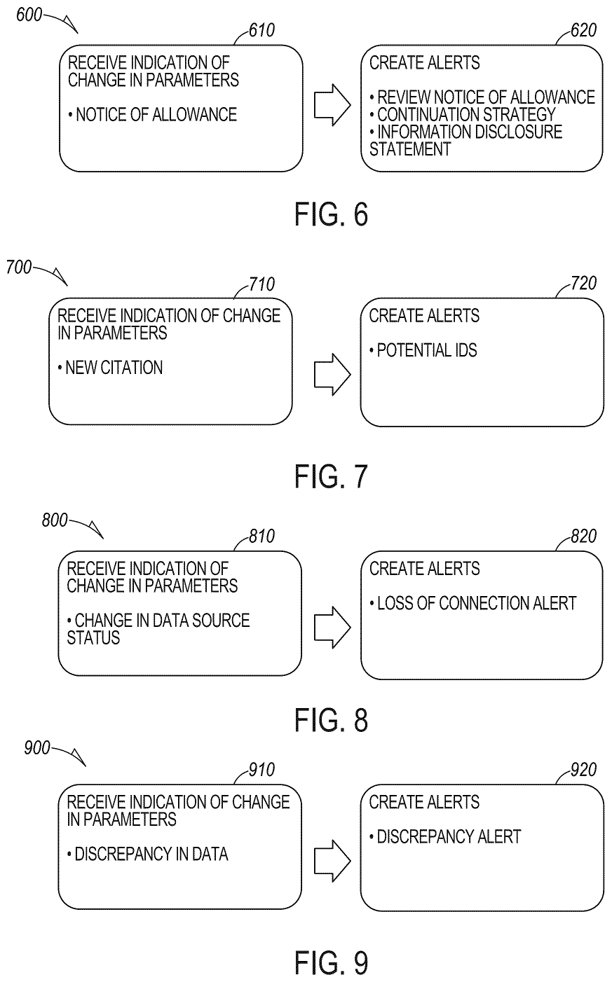

FIG. 6 depicts a method 600 of using a spreadsheet alert tool in an example. The method 600 can include receiving an indication in a change in the one or more parameters (step 610). In the example of method 600, this can include receiving a notification of a notice of allowance in a matter on the database user interface.

Next, at step 620, the spreadsheet alert tool can create one or more embedded alerts related to the change in parameter—in this case, a change in status from “pending” to “allowed”. The spreadsheet alert tool can create one or more embedded alerts for the matter on which the status has changed from “pending” to “allowed”. For example, the spreadsheet alert tool can create an alert of status change but can also create alerts to review the notice of allowance for examiner's amendment, review the notice of allowance for examiner's reasons for allowance, review the case for potential continuation or divisional filings, and file a potential information disclosure statement prior to payment of an issue fec.

In method 600, once a change in status from “pending” to “allowed” has been indicated, a phase rule can be triggered which will alert the user if a potential information disclosure statement has not been filed one week prior to the due date, for example. If, at one week prior to the due date, the statement has not been filed, an identification code can be established which will embed the one or more alerts into the spreadsheet user interface, for example.

FIG. 7 depicts a method 700 of using a spreadsheet alert tool in an example. The method 700 can include receiving an indication in a change in the one or more parameters (step 710). In the example of method 700, this can include receiving a notification of a new citation in the matter. In this case, at step 720, the spreadsheet alert tool can create one or more embedded alerts, indicating the new citation should be reviewed, and potentially an information disclosure statement should be produced.

In method 700, once a notification of a new citation in the matter has been received, and a change of parameters is indicated, a phase rule can be triggered which will alert the user after a specified period of time that an information disclosure statement may need to be filed. An identification code can be established with the applied phase rule which will trigger the embedding of one or more alerts.

FIG. 8 depicts a method 800 of using a spreadsheet alert tool in an example. The method 800 can include receiving an indication in a change in the one or more parameters (step 810). In the example of method 800, this can include receiving an indication of a change in the status of a data source for the matter. For example, this could be a loss of connection between the database tool and the data source.

In this case, at step 820, the spreadsheet alert tool can produce an embedded alert that notifies the user of an error in connectivity, a discrepancy in data, or both. This can also include an indication of an error state as desired.

In method 800, once a notification of a change in data source status is received, and a change of parameters is indicated, a phase rule can be triggered which can alert the user after a specified period of time that there has been a loss of connection. An identification code can be established with the applied phase rule which can trigger the embedding of one or more alerts if the identification code is fulfilled.

FIG. 9 depicts a method 900 of using a spreadsheet alert tool in an example. The method 900 can include receiving an indication in a change in the one or more parameters (step 910). Example method 900 can include a notification of a discrepancy in data on the plurality of matters. Creating one or more embedded alerts (step 920) can include notifying a user of the discrepancy. The discrepancy can occur between two different sources of data related to the matter.

In method 900, once a notification of a discrepancy in data is received, and a change of parameters is indicated, a phase rule can be triggered which can alert the user after a specified period of time that there is a discrepancy in data. An identification code can be established with the applied phase rule which can trigger the embedding of one or more alerts if the identification code is fulfilled. For example, a phase rule may be applied which can be triggered if the discrepancy in data is not corrected within 24 hours. Once the phase rule is applied, an identification code is established. If, after 24 hours, the discrepancy is not corrected, the phase rule is triggered, and the established identification code is fulfilled. This method can result in the embedding of one or more alerts in the spreadsheet user interface.

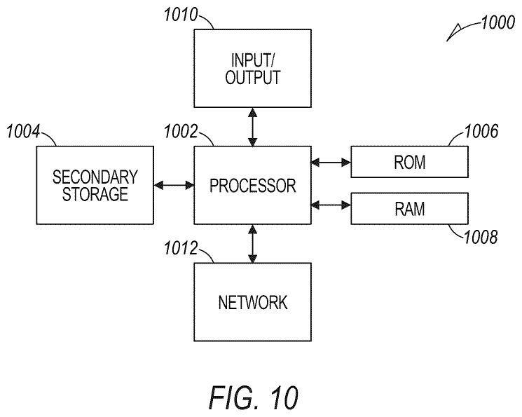

FIG. 10 is a block diagram of a typical, general-purpose computer 1000 that may be programmed into a special purpose computer suitable for implementing one or more embodiments of the manifest record generating program disclosed herein. The manifest record generating program described above may be implemented on any general-purpose processing component, such as a computer with sufficient processing power, memory resources, and communications throughput capability to handle the necessary workload placed upon it. The computer 1000 includes a processor 1002 (which may be referred to as a central processor unit or CPU) that is in communication with memory devices including secondary storage 1004, read only memory (ROM) 1006, random access memory (RAM) 1008, input/output (I/O) devices 1010, and network connectivity devices 1012. The processor 1002 may be implemented as one or more CPU chips or may be part of one or more application specific integrated circuits (ASICs).

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs that are loaded into RAM 1008 when such programs are selected for execution. The ROM 1006 is used to store instructions and perhaps data that are read during program execution. ROM 1006 is a non-volatile memory device that typically has a small memory capacity relative to the larger memory capacity of secondary storage 1004. The RAM 1008 is used to store volatile data and perhaps to store instructions. Access to both ROM 1006 and RAM 1008 is typically faster than to secondary storage 1004.

The devices described herein may be configured to include computer-readable non-transitory media storing computer-readable instructions and one or more processors coupled to the memory, and when executing the computer readable instructions configure the computer 1000 to perform method steps and operations described above with reference to FIG. 5 to FIG. 9. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through a physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory, a random-access memory, or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatuses or devices. The term “machine-readable medium” as used herein excludes signals per se.

### Various Notes & Examples

Example 1 is a method comprising: producing a user-configurable spreadsheet user interface, the spreadsheet user interface describing a plurality of matters, wherein each of the plurality of matters is associated with one or more parameters; receiving an indication in a change in the one or more parameters; creating one or more embedded alerts in the spreadsheet user interface according to the change in the one or more parameters, each of the one or more embedded alerts associated with one of the plurality of matters; and notifying a user of the one or more embedded alerts in the spreadsheet user interface.

In Example 2, the subject matter of Example 1 optionally includes wherein producing the user-configurable spreadsheet user interface comprising automatically producing data from a docketing system.

In Example 3, the subject matter of any one or more of Examples 1-2 optionally includes wherein producing the user-configurable spreadsheet comprises scraping case data from a governmental database.

In Example 4, the subject matter of any one or more of Examples 1-3 optionally includes wherein the plurality of matters comprises patent cases.

In Example 5, the subject matter of any one or more of Examples 1-4 optionally includes wherein the one or more parameters comprise at least a status of plurality of matters.

In Example 6, the subject matter of Example 5 optionally includes wherein the status comprises one or more of unfiled, pending, published, allowed, granted, issued, expired, completed, restricted, rejected, finally rejected, appealed, or other status indicators.

In Example 7, the subject matter of any one or more of Examples 1-6 optionally includes wherein receiving an indication in a change in the one or more parameters comprises receiving a notification of a notice of allowance.

In Example 8, the subject matter of Example 7 optionally includes wherein creating the one or more embedded alerts comprises creating an alert of potential information disclosure statement.

In Example 9, the subject matter of any one or more of Examples 1-8 optionally includes wherein receiving an indication in a change in the one or more parameters comprises receiving a notification of a new citation.

In Example 10, the subject matter of Example 9 optionally includes wherein creating the one or more embedded alerts comprises creating an alert of potential information disclosure statement.

In Example 11, the subject matter of any one or more of Examples 1-10 optionally include wherein the one or more parameters comprise at least a status of a data source of the plurality of matters.

In Example 12, the subject matter of Example 11 optionally includes wherein the one or more parameters comprise a change in the status of the data source.

In Example 13, the subject matter of Example 12 optionally includes wherein the change in the status of the data source comprises a loss of connection between the database tool and the data source.

In Example 14, the subject matter of any one or more of Examples 1-13 optionally includes wherein the one or more parameters comprises a discrepancy in data on the plurality of matters.

In Example 15, the subject matter of Example 14 optionally includes wherein creating one or more embedded alerts comprises notifying a user of the discrepancy.

In Example 16, the subject matter of any one or more of Examples 14-15 optionally include wherein the discrepancy occurs between two different sources of data related to the matter.

In Example 17, the subject matter of any one or more of Examples 1-16 optionally include wherein receiving an indication in a change in the one or more parameters comprises receiving an indication of an error condition parameters that are related.

Example 18 is a computer readable medium including a processor and a memory, the memory including instructions which when executed, cause the processor to: produce a user-configurable spreadsheet user interface, the spreadsheet user interface describing a plurality of matters, wherein each of the plurality of matters is associated with one or more parameters; receive an indication in a change in the one or more parameters; create one or more embedded alerts in the spreadsheet user interface according to the change in the one or more parameters, each of the one or more embedded alerts associated with one of the plurality of matters; and notify a user of the one or more embedded alerts in the spreadsheet user interface.

In Example 19, the subject matter of Example 18 optionally includes wherein producing the user-configurable spreadsheet user interface comprising automatically producing a data from a docketing system.

In Example 20, the subject matter of any one or more of Examples 18-19 optionally include wherein producing the user-configurable spreadsheet user interface comprises scraping case data from a governmental database.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
producing a user-configurable spreadsheet user interface, the spreadsheet user interface describing a plurality of matters, wherein each of the plurality of matters is associated with one or more parameters;
receiving an indication in a change in the one or more parameters;
creating one or more embedded alerts in the spreadsheet user interface according to the change in the one or more parameters, each of the one or more embedded alerts associated with one of the plurality of matters; and
notifying a user of the one or more embedded alerts in the spreadsheet user interface.

2. The method of claim 1, wherein producing the user-configurable spreadsheet user interface comprising automatically producing data from a docketing system.

3. The method of claim 1, wherein producing the user-configurable spreadsheet user interface comprises scraping case data from a governmental database.

4. The method of claim 1, wherein the plurality of matters comprises patent cases.

5. The method of claim 1, wherein the one or more parameters comprises at least a status of each of the plurality of matters.

6. The method of claim 5, wherein the status comprises one or more of unfiled, pending, published, allowed, granted, issued, expired, completed, restricted, rejected, finally rejected, appealed, or other status indicators.

7. The method of claim 1, wherein receiving an indication in a change in the one or more parameters comprises receiving a notification of a notice of allowance.

8. The method of claim 7, wherein creating the one or more embedded alerts comprises creating an alert of a potential information disclosure statement.

9. The method of claim 1, wherein receiving an indication in a change in the one or more parameters comprises receiving a notification of a new citation.

10. The method of claim 9, wherein creating the one or more embedded alerts comprises creating an alert of a potential information disclosure statement.

11. The method of claim 1, wherein the one or more parameters comprises at least a status of a data source of the plurality of matters.

12. The method of claim 11, wherein the one or more parameters comprises a change in the status of the data source.

13. The method of claim 12, wherein the change in the status of the data source comprises a loss of connection between a database tool and the data source.

14. The method of claim 1, wherein the one or more parameters comprises a discrepancy in data associated with at least one of the plurality of matters.

15. The method of claim 14, wherein creating one or more embedded alerts comprises notifying a user of the discrepancy.

16. The method of claim 14, wherein the discrepancy occurs between two different sources of data related to at least one of the plurality of matters.

17. The method of claim 1, wherein receiving an indication in a change in the one or more parameters comprises receiving an indication of an error condition between parameters that are related.

18. A computer-readable medium including a processor and a memory, the memory including instructions which when executed, cause the processor to:
produce a user-configurable spreadsheet user interface, the spreadsheet-user interface describing a plurality of matters, wherein each of the plurality of matters is associated with one or more parameters;
receive an indication in a change in the one or more parameters;
create one or more embedded alerts in the spreadsheet user interface according to the change in the one or more parameters, each of the one or more embedded alerts associated with one of the plurality of matters; and
notify a user of the one or more embedded alerts in the spreadsheet user interface.

19. The medium of claim 18, wherein producing the user-configurable spreadsheet-user interface comprises automatically producing data from a docketing system.

20. The medium of claim 18, wherein producing the user-configurable spreadsheet user interface comprises scraping case data from a governmental database.
